(19) United States
(12) Patent Application Publication
(10) Pub. No.: US 2005/0188125 A1
(43) Pub. Date: Aug. 25, 2005

(54) Method and apparatus for burst mode data transfers between a CPU and a FIFO

(76) Inventors: Ricardo Te Lim, Richmond (CA); Tatiana Pavlovna Kadantseva, Vancouver (CA)

Correspondence Address: EPSON RESEARCH AND DEVELOPMENT INC;INTELLECTUAL PROPERTY DEPT, 150 RIVER OAKS PARKWAY, SUITE 225, SAN JOSE, CA, 95134, US

(21) Appl. No.: 10/783,287

(22) Filed: Feb. 20, 2004

(51) Int. Cl. G06F 13/28

(52) U.S. Cl. 710/35

(57) ABSTRACT

A method and apparatus for burst mode data transfers between a CPU and a FIFO. The CPU executes a burst mode memory access instruction defining multiple memory addresses. The multiple memory addresses are decoded to produce an output that is the same for each of the multiple memory addresses. The FIFO is accessed repeatedly, for each of the multiple addresses, by use of the output.

### FIELD OF THE INVENTION

The present invention relates to a method and apparatus for burst mode data transfers between a CPU and a FIFO (“first-in-first-out”) memory.

### BACKGROUND

FIFO memories are often employed as buffers between a CPU and a peripheral device in order to facilitate the transfer of data. For example, a cellular telephone includes a CPU adapted to interface via a FIFO with a peripheral camera. Another example of the use of FIFO memories is in a UART (“Universal Asynchronous Receiver Transmitter”), where the UART interfaces between a parallel bus coupled to the CPU and a peripheral device adapted for serial communications. FIFO memories are ordinarily accessible only through a single memory address.

CPU's are commonly provided with “burst” mode instructions for transferring data between corresponding memory spaces. For example, processors known in the art by the tradename “ARM” provide for a “Read Multiple” and a “Write Multiple” instruction that efficiently transfers a block of data from one contiguous memory space to another. Particularly, the “Read Multiple” instruction of the ARM processor provides for reading 32 bytes of data from a contiguous memory space and storing the 32 bytes of data in internal registers with a single instruction fetch. Similarly, the “Write Multiple” instruction provides for writing 32 bytes of data from the internal registers to a contiguous memory space, with a single instruction fetch. Without such burst mode capabilities, the processor can read or write only 4 bytes per instruction fetch and the contents of an address register must be incremented each time. In addition, implementing a read or write multiple instruction in software requires the execution of a loop which adds further processing overhead.

The burst mode instructions, “Read Multiple” and “Write Multiple,” therefore permit the CPU to function much more efficiently, by saving many of the clock cycles that would ordinarily be required. However, the burst mode instructions require a contiguous block of memory identified by sequential addresses with which to interact and therefore do not work with a FIFO, which is identified with a single address. Accordingly, there is a need for a method and apparatus for burst mode data transfers between a CPU and a FIFO.

### SUMMARY

A preferred method and apparatus is provided for burst mode data transfers between a CPU and a FIFO. The CPU executes a burst mode memory access instruction defining multiple memory addresses. The multiple memory addresses are decoded to produce an output that is the same for each of the multiple memory addresses. The FIFO is accessed repeatedly, for each of the multiple memory addresses, by use of the output. Preferably, the multiple addresses are placed sequentially on a bus, and the multiple memory addresses are sequentially received from the bus for decoding.

### BRIEF DESCRIPTION OF THE DRAWINGS

FIG. 1 is a block diagram of a prior art memory system employing a CPU, a memory, and a prior art UART having a read FIFO and a write FIFO.

FIG. 2 is a block diagram of a portion of the UART of FIG. 1, showing a prior art read control circuit for interfacing with the FIFO.

FIG. 3 is a timing diagram illustrating a simple address and data cycle for reading data from the read FIFO of FIG. 1.

FIG. 4 is a block diagram of a memory system employing a CPU, a memory, and a UART according to the present invention having a read FIFO and a write FIFO.

FIG. 5 is a block diagram of a portion of the UART of FIG. 4, showing a read control module according to the present invention for use with the read FIFO of the UART of FIG. 4.

FIG. 6 is a block diagram of the read control module of FIG. 5, shown in more detail.

FIG. 7A is a timing diagram for a conventional method of transferring 32 bytes of data to a FIFO.

FIG. 7B is a timing diagram for a method for transferring 32 bytes of data to a FIFO according to the present invention.

### DETAILED DESCRIPTION OF A PREFERRED EMBODIMENT

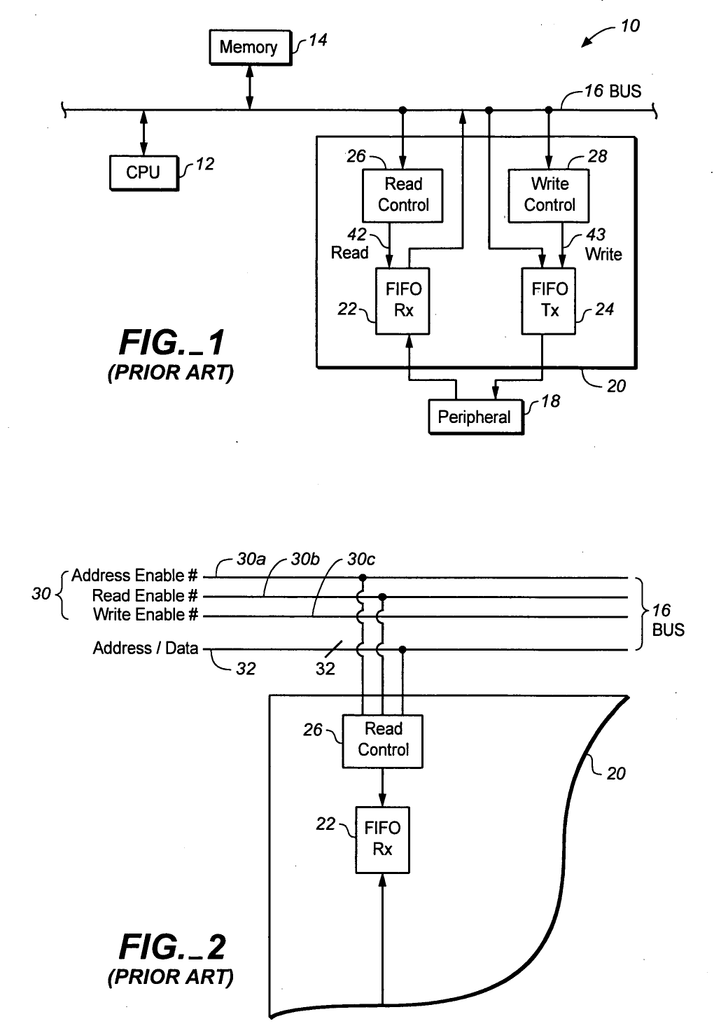

FIG. 1 shows an exemplary computer system 10, which may be a cellular telephone, a personal digital assistant, a pager, a personal computer, or other similar system. The system 10 includes a CPU 12 and a memory 14. The CPU 12 interacts with the memory 14 over a bus 16, and other computers, devices, and peripherals may be coupled to the bus. In particular, a peripheral 18 is coupled to the bus 16 through a circuit 20 that includes at least one FIFO memory. The bus 16 comprises a control bus 30 and an address/data bus 32 (shown in FIG. 2).

More particularly, as exemplary context for the present invention, the circuit 20 may be a UART containing two FIFOs, e.g., a read FIFO RX (22) and a write FIFO TX (24); however, it will be understood that a single FIFO may be used for both reading and writing. Because there are two FIFOs, the circuit 20 preferably includes separate control circuits for controlling each FIFO, e.g., a read control circuit 26 for controlling the FIFO RX (22) and a write control circuit 28 for controlling the FIFO TX (24). However, it will be understood that a single control circuit incorporating both functions may be used.

The output of the read control circuit 26 is a READ signal 42 that, when active, causes the FIFO RX (22) to output four bytes to the bus 16. Similarly, the write control circuit 28 outputs a WRITE signal 43 to the FIFO TX (24) to cause the FIFO TX to sample four bytes from the bus 16.

Turning to FIG. 2, a block diagram of a portion of the UART of FIG. 1 is shown. To execute memory transfers, the CPU 12 generally issues address and control signals over the bus 16. Particularly, control signals are carried over control bus 30, while addresses and data are carried over the address/data bus 32. The control signals in this example comprise address enable 30a, read enable 30b, and write enable 30c. The CPU may direct memory transfers between the memory 14 and the FIFOs 22 and 24, between internal memory registers in the CPU and the FIFOs, or between the FIFOs and any other device or memory coupled to the bus.

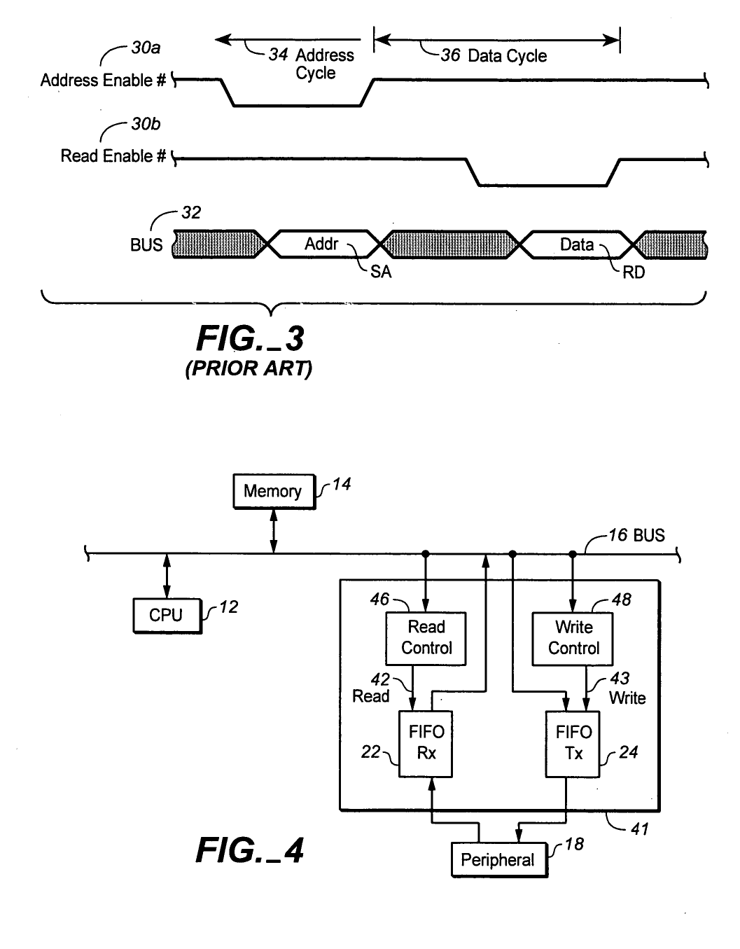

Turning to FIG. 3, an exemplary timing diagram shows a portion of an address cycle 34 and a data cycle #1 (36) for a typical READ instruction executed by the CPU 12. (The ADDRESS ENABLE # (30a) and READ ENABLE # (30b) signals are active low.) The READ instruction defines a single memory address “SA.” Initially, READ ENABLE # is high, and the CPU places the memory address “SA” on the address/data bus 32. Subsequently, the ADDRESS ENABLE # signal transitions from low to high, which causes the memory address “SA” to be latched into the read control circuit 26. This completes the address cycle 34.

The memory address “SA” is decoded by the read control circuit 26 and, if it matches the address of a read address register (not shown) for the FIFO RX (22), the read control circuit 26 causes the FIFO RX 22 to place the data “RD” that it has is stored within it on the bus 32. During the data cycle 36, ADDRESS ENABLE # is high, and on the transition of READ ENABLE # from low to high, the CPU samples the data “RD” from the bus 32.

The same principle of operation applies in reverse for a WRITE instruction, through use of a write address register (also not shown) of the FIFO TX (24).

The CPU's READ and WRITE instructions can be used to effectuate a pseudo “burst mode” by employing a software loop as is well known. However, the CPU 12 also supports hardware burst memory access instructions. The system described herein assumes instructions for an ARM processor, e.g., the ARM7TDMI, but it should be understood that any other processor having similar features may be used. The exemplary ARM7TDMI CPU provides a “Read Multiple” instruction whereby 32 bytes of data are read from contiguous specified memory locations in a burst and stored in internal registers, and provides a corresponding “Write Multiple” instruction whereby 32 bytes of data are written from the CPU's internal registers to specified contiguous memory locations in a burst. While the burst mode instructions preferably employ registers internal to the CPU, registers external to the CPU may be employed without departing from the principles of the invention provided the external registers may be accessed by the CPU within an appropriate time frame.

In a burst mode transfer from the CPU to a memory, the memory address is incremented in hardware to provide, with minimum processing overhead, a range of multiple addresses for accessing respective multiple memory locations. Typically, as in the ARM processor, the burst mode instructions increment the memory address monotonically in steps of 1, corresponding to contiguous memory locations defining a block of memory space, but this is not essential. Using these instructions, the bus timing shown in FIG. 3 looks the same, but the CPU 12 operates more efficiently. However, as mentioned above, the burst mode instructions cannot be used for addressing a FIFO, because a FIFO is identified by a single address.

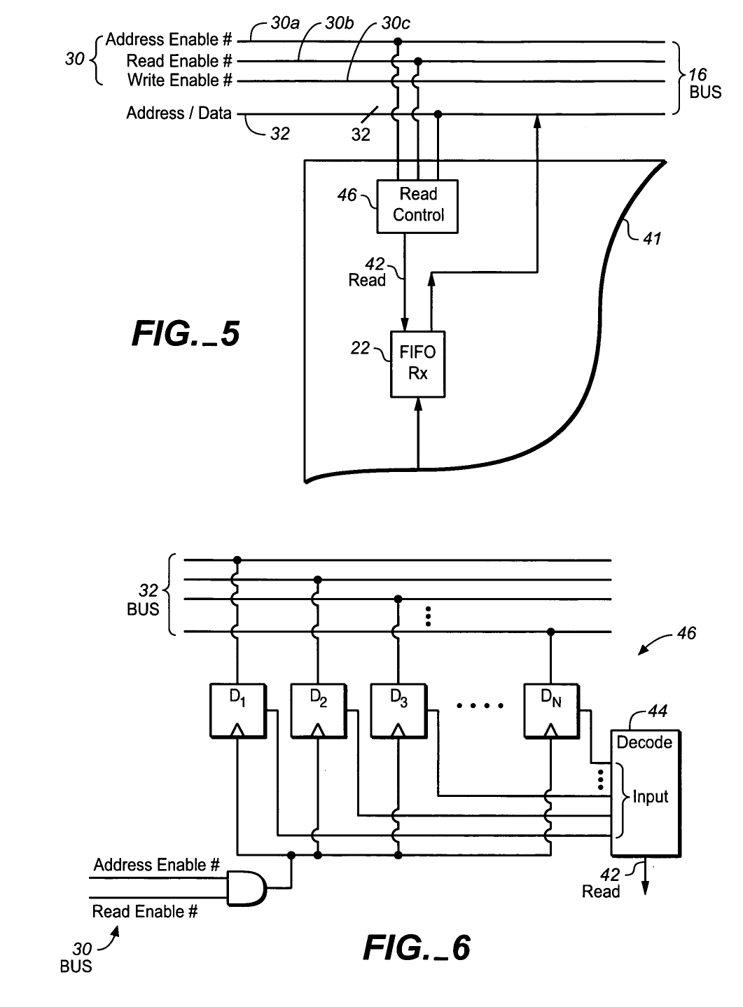

According to the invention, the CPU accesses the read FIFO RX (22) and the write FIFO TX (124) in burst modes, wherein a FIFO is repeatedly accessed using a set of predetermined multiple addresses. FIG. 4 shows a circuit 41 corresponding to the circuit 20 of FIG. 1. The circuit 41 includes a read control circuit 46 according to the invention for controlling the FIFO RX (22) and a write control circuit 48 according to the invention for controlling the FIFO RX (24). Just as FIG. 2 shows a portion of the circuit 20 of FIG. 1, FIG. 5 shows a portion of the circuit 41 of FIG. 4.

In FIG. 5, the read control circuit 46 is shown as being provided with the signals indicated in FIG. 3 described above as input. The output of the read control circuit 46 is a READ signal 42 that, when active, causes the FIFO RX (22) to output four bytes to the bus 16. Similarly, the write control circuit 48 (FIG. 4; omitted from FIG. 5) is provided with the same signals for causing the FIFO TX (24) to sample four bytes from the bus 16 as a consequence of receiving a WRITE signal 43.

Turning to FIG. 6, the read control circuit 46 of FIG. 5 is shown in more detail. The circuit 46 latches address bits received from the address/data bus 32 in response to control signals received from the control bus 30. Each bit of address or data is latched at respective rising edge triggered D flip-flops (D₁ . . . D_{N}), the output of the flip-flops being decoded by a decoder 44. The decoder 44, which may be implemented with combinational logic, asserts the READ signal 42 whenever the address is within a predetermined range of addresses. Preferably, the READ decoder is adapted to assert the READ signal in response to incremental changes in the address between a lower address and an upper address and to de-assert the READ signal when the address has any other value. The same implementation may be used for the write control circuit 48, where the decoder asserts a WRITE signal to cause the FIFO TX (24) to be written as indicated above.

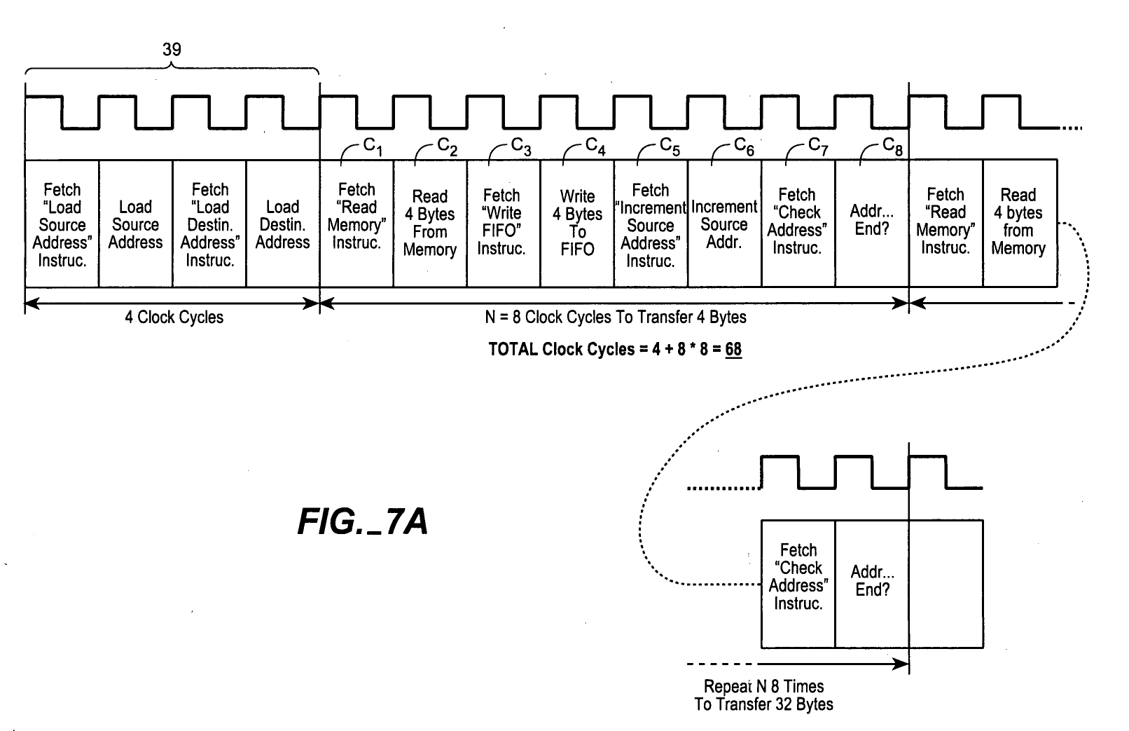

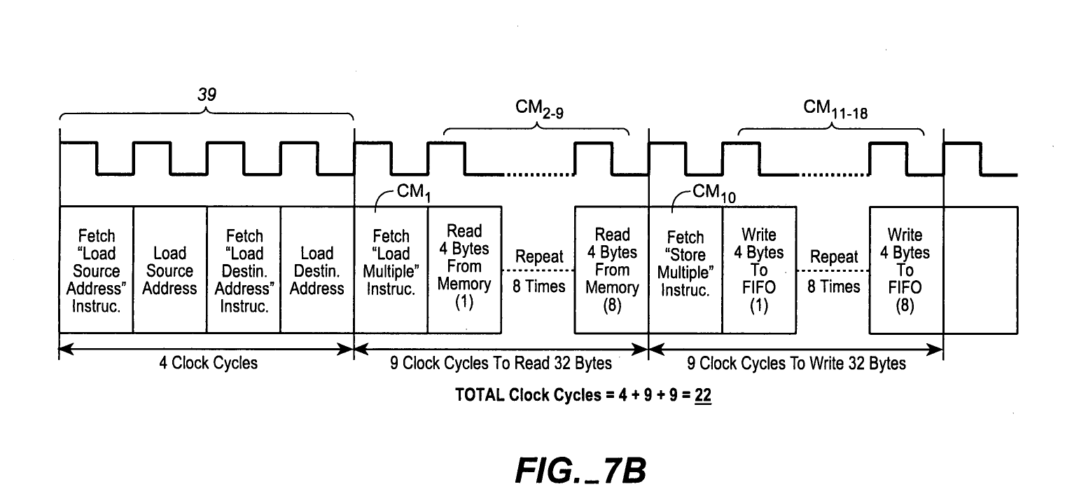

The invention provides for an outstanding savings in CPU overhead. Turning to FIG. 7A, a timing diagram for a conventional method for transferring 32 bytes from a memory to a FIFO is shown. The exemplary ARM CPU can read or write four bytes of data at a time. For simplicity of illustration, it is assumed that instruction fetches, memory reads, and FIFO writes all require only one clock cycle.

In a set-up step 39, four clock cycles are first required to establish the first source address and the FIFO destination address. Eight clock cycles are then required to transfer consecutive blocks of four bytes of data as a result of the following actions: (1) instruction fetch “read memory” (clock cycle C₁); (2) read 4 bytes from the memory (clock cycle C₂); (3) instruction fetch “write FIFO” (clock cycle C₃); (4) write 4 bytes to the FIFO (clock cycle C₄); (5) fetch “increment source address” instruction (clock cycle C₅); (6) increment the source address (clock cycle C₆); (7) instruction fetch “check address” (clock cycle C₇); and (8) check the address to determine whether 32 bytes have been transferred (clock cycle C₈). Accordingly 4+(N·8)=68 clock cycles are required for transferring 32 bytes (where N=32/4=8).

The 68 clock cycles required for transferring 32 bytes conventionally is reduced as shown in FIG. 7B to just 22 clock cycles. Four clock cycles are required initially to establish the source and destination address as before (step 39). However, reading 32 bytes from the memory requires only one instruction fetch for the instruction “Read Multiple” (CM₁) followed by eight read cycles for reading eight blocks (CM₂₋₉), each block having four bytes of data, and one instruction fetch for the instruction “Write Multiple” (CM₁₀) followed by eight write cycles for writing the eight blocks (CM₁₁₋₁₈). Accordingly, CPU time is reduced by over two-thirds. As will be readily appreciated, a similar result is obtained for transferring 32 bytes of data from the FIFO.

It will be immediately appreciated by persons of ordinary skill in the art that the above-described functionality may be implemented in hardware by a number of different means. Moreover, methods and apparatus according to the invention may be implemented in hardware, software, or both, and machine readable media may be provided embodying one or more programs of instructions executable by the machine to perform one or more methods according to the invention. In addition, it is to be recognized that while a particular methods and apparatus for efficient transfer of data between a FIFO and a RAM have been shown and described as preferred, other configurations and methods could be utilized, in addition to those already mentioned, without departing from the principles of the invention.

The terms and expressions which have been employed in the foregoing specification are used therein as terms of description and not of limitation, and there is no intention in the use of such terms and expressions to exclude equivalents of the features shown and described or portions thereof, it being recognized that the scope of the invention is defined and limited only by the claims which follow.

1. A method for burst mode data transfers between a CPU and a FIFO, the CPU adapted to execute a burst mode memory access instruction defining multiple memory addresses, the method comprising the steps of:
decoding the multiple memory addresses to produce an output that is the same for each of the multiple memory addresses; and
accessing the FIFO repeatedly, for each of the multiple addresses, by use of said output.

2. The method of claim 1, the method further comprising placing the multiple memory addresses sequentially on a bus, and sequentially receiving the multiple memory addresses from the bus for said step of decoding.

3. The method of claim 1, wherein said step of accessing is read accessing.

4. The method of claim 1, wherein said step of accessing is write accessing.

5. An apparatus for burst mode data transfers by a CPU, the CPU adapted to execute a burst mode memory access instruction defining multiple memory addresses, comprising:
a FIFO; and
a decoder, said decoder adapted for receiving and decoding the multiple memory addresses so as to produce an output that is the same for each of said multiple memory addresses, and providing said output to said FIFO for accessing said FIFO.

6. The apparatus of claim 5, wherein the CPU and said decoder are coupled to a bus, wherein said decoder is adapted to sequentially receive the multiple memory addresses from the bus.

7. The apparatus of claim 5, wherein said output of said decoder is for read accessing said FIFO.

8. The apparatus of claim 5, wherein said output of said decoder is for write accessing said FIFO.

9. A medium readable by a machine embodying a program of instructions executable by the machine to perform a method for burst mode data transfers between a CPU and a FIFO, the CPU adapted to execute a burst mode memory access instruction defining multiple memory addresses, the method comprising the steps of:
decoding the multiple memory addresses to produce an output that is the same for each of the multiple memory addresses; and
accessing the FIFO repeatedly, for each of the multiple addresses, by use of said output.

10. The medium of claim 9, wherein the method further comprises placing the multiple memory addresses sequentially on a bus, and sequentially receiving the multiple memory addresses from the bus for said step of decoding.

11. The medium of claim 9, wherein the method further comprises read accessing the FIFO.

12. The medium of claim 9, wherein the method further comprises write accessing the FIFO.

13. A system for burst mode data transfers, comprising:
a CPU adapted to execute a burst mode memory access instruction defining multiple memory addresses;
a FIFO; and
a decoder, said decoder adapted for receiving and decoding the multiple memory addresses so as to produce an output that is the same for each of said multiple memory addresses, and providing said output to said FIFO for accessing said FIFO.

14. The system of claim 13, further comprising a bus, wherein said CPU and said decoder are coupled to said bus, wherein said decoder is adapted to sequentially receive the multiple memory addresses from said bus.

15. The system of claim 13, wherein said output of said decoder is for read accessing said FIFO.

16. The system of claim 13, wherein said output of said decoder is for write accessing said FIFO.
